(19) United States
(12) Patent Application Publication
(10) Pub. No.: US 2025/0211430 A1
(43) Pub. Date: Jun. 26, 2025

(54) CENTRALIZED SATELLITE QUANTUM CRYPTOGRAPHIC KEY PAIRING METHOD

(71) Applicant: THALES, MEUDON (FR)

(72) Inventors: Fabrice ARNAL, CUGNAUX (FR); Laurent DE FORGES DE PARNY, TOURNEFEUILLE (FR)

(21) Appl. No.: 18/988,723

(22) Filed: Dec. 19, 2024

(30) Foreign Application Priority Data
Dec. 21, 2023 (FR) 2314794

(51) Int. Cl. H04L 9/08

(52) U.S. Cl. CPC H04L 9/0852

(57) ABSTRACT

A centralized satellite quantum cryptographic key pairing method for ground stations includes a quantum key distribution step, wherein, for each station, a cryptographic key is shared through quantum communication between the station and a satellite; a centralized key storage step, wherein each key is first transmitted in encrypted form from the satellite to a terrestrial central key management unit (UC), and then stored by this unit (UC); and a pairing step between a first and a second of the stations, wherein, upon receipt of a communication request, the unit (UC) transmits the key linked to the second station, in encrypted form, to the first station.

The invention relates to a centralized satellite quantum cryptographic key pairing method for a plurality of ground stations. The invention also relates to a centralized satellite quantum cryptographic key pairing system for a plurality of ground stations, using a method according to the invention.

There is interest in allowing sensitive information to be exchanged via an open communication channel, such as for example a wireless communication channel, while still preserving its secrecy. An open communication channel or open link is understood to mean a communication channel or link the content of which is able to be intercepted by a third party without the transmitter and the receiver being able to detect this. Such a problem is typically represented by a situation in which two people, Alice and Bob, wish to exchange sensitive information away from prying eyes, through an authenticated open communication channel (for example the Internet). For this purpose, there are cryptographic techniques using which Alice and Bob encrypt their messages. Symmetric cryptographic techniques using only a shared private key (also called “shared secret”), and asymmetric cryptographic techniques based on a combination of public and private keys, are known. The principle of a symmetric cryptographic technique is detailed briefly below. The person wishing to intercept these messages will be called Eve. Alice, using a cryptographic function and a private key shared with Bob, encrypts her messages before sending them to Bob through an open channel. When Bob receives the encrypted messages, he decrypts them using the same cryptographic function and the shared private key, in order to be able to access the information in plaintext. Eve, who does not have the key, will not be able to decrypt the message.

In the implementation of symmetric cryptographic techniques, one crucial issue is that of keeping the secret, notably how to share the secret key securely between Alice and Bob, away from prying eyes.

A new solution was devised at the end of the 20th century, proposing to use quantum communications to share a common key securely between Alice and Bob. Quantum communication consists in establishing a quantum link between a transmitter and a receiver in order to exchange information. The quantum link comprises notably an optical link transmitting a series of photons. A qubit (or qbit) is the quantum information carried by a photon. This information is for example encoded in the polarization state of the photon.

The quantum key distribution (QKD) method designates a cryptographic protocol aimed at establishing a secret key shared between two participants, Alice and Bob, using quantum communication. By virtue of quantum properties, notably those due to the quantum no-cloning theorem, any attempt to attack the communication, such as an eavesdropping attempt made by a third party Eve, is able to be detected with certainty by Alice and Bob, thereby allowing them to quickly invalidate the key. The QKD method thereby enables secure establishment of a symmetric cryptographic key.

The prepare and measure (or P&M) protocol is one example of a known QKD method. In this P&M protocol, the transmitter Alice encodes a conventional bit (0 or 1) in an individual optical signal, notably a photon, before transmitting it, in the form of a qubit, to the receiver Bob. Bob carries out a set of specific measurements on each of the individual optical signals, such as photons, transmitted by Alice with a view to retrieving the encoded bits. One example of a P&M protocol is the BB84 protocol, in which the polarization of an individual photon makes it possible to encode a bit. The BB84 protocol is described notably in the publication “Quantum cryptography: Public key distribution and coin tossing”, Charles H. Bennett and Gilles Brassard, Theoretical Computer Science, vol. 560, 1984, p. 7-11 (DOI: 10.1016/j.tcs.2014.05.025).

When Alice and Bob are users on the ground, the quantum link may be implemented via an optical fiber-borne optical communication channel. However, in optical fibers, optical signals are progressively attenuated, thereby permitting a quantum link only up to a limit distance, typically around 100 km. For quantum key distribution over a longer distance, it is known to propagate the key via one or more what are known as “trusted” nodes placed at regular intervals (typically every 100 kilometers). Such a trusted node, positioned between Alice and Bob, makes it possible to extend the range for establishing a key through quantum communication. To this end, the trusted node manipulates, in plaintext, a key K_{A} shared through quantum communication with Alice and a key K_{B} shared through quantum communication with Bob. The trusted node therefore has to be secured with a very high level of security. Next, the trusted node takes notably the one-time pad (OTP) encryption technique as a basis for transmitting, to Bob, the key K_{A} previously shared with Alice. To this end, the trusted node applies an XOR function, that is to say an “exclusive OR” function, between the key K_{A} shared with Alice and the key K_{B} shared with Bob, so as to obtain a parity sequence K_{A}@K_{B}. The XOR function between two elements is represented by the symbol O. The parity sequence K_{A}@K_{B} is transmitted to Bob via an authenticated open channel. Bob, who holds the key K_{B}, will again be able to carry out an XOR function between the sequence received from the trusted node and his key K_{B} so as to recover Alice's key K_{A}. This is based on the property of the XOR function whereby K_{A}⊕KBEKB=KAG (KBOKB)=K_{A} but also on the one-time pad encryption technique, which guarantees that it is not possible to find out one of the keys K_{A}, K_{B} with knowledge only of the sequence K_{A}⊕K_{B} However, a fiber-optic connection between two users separated by an ocean may be disadvantageous in terms of guaranteeing security, because it requires a large number of trusted nodes.

It is known to exchange optical signals in free-field mode, that is to say in particular from space, via a satellite and a ground station equipped with a telescope. The quantum link is then implemented by a laser source, notably in the infrared or near-infrared. When it passes through the vacuum of space and the Earth's atmosphere, the laser signal implementing the quantum communication experiences less attenuation, at least over long distances, compared to propagation in an optical fiber. The publication “Progress in satellite Quantum Key Distribution”, Robert Bedington, Juan Miguel Arrazola, Alexander Ling, npj Quantum Information 3, Article number: 30 (2017) (DOI: 10.1038/s41534-017-0031-5) describes some satellite QKD methods.

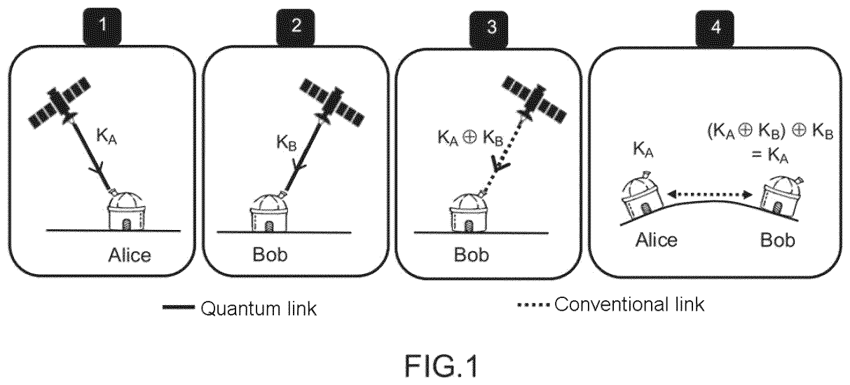

FIG. 1 illustrates one conventional example of satellite quantum key distribution. In a first step, the satellite makes it possible to establish a shared key K_{A} with the ground station Alice through quantum communication. After having moved in its orbit, in a second step, the satellite makes it possible to establish a second shared key K_{B} with the ground station Bob through quantum communication. Next, in a third step, the satellite transmits, to Bob, the parity sequence K_{A}@K_{B} resulting from an XOR function applied to the keys K_{A}, K_{B}. The parity sequence K_{A}⊕K_{B} is transmitted over an open communication channel, in particular a non-quantum communication channel, for example by an optical or radiofrequency RF link. In a fourth step, Bob may then extract Alice's key K_{A} by carrying out an XOR function between his own key K_{B} and the parity sequence K_{A}⊕K_{B} that the satellite transmitted to him. The key K_{A} is thus finally shared between Alice and Bob. They may then use this key K_{A} to encrypt communications between them on an open communication channel. By moving relative to Alice and relative to Bob, the satellite acts as a mobile space-based trusted node. Key sharing between Alice and Bob may therefore be achieved regardless of the distance between them, provided that the same satellite flies over the two stations.

Since the quantum signals that are used are inherently of very low intensity, it is preferred to use a low Earth orbit satellite rather than a geostationary satellite, which has a higher orbit. This means that temporal visibility is reduced for a given station. In addition, the laser flux, which is the medium for quantum communication, remains highly sensitive to weather and environmental conditions between the ground station and the satellite. For example, clouds or atmospheric turbulence may disturb or even block the optical signal. For each ground station, the satellite therefore has to wait until conditions are favorable for establishing a key through quantum communication. The delay in implementing a pairing request between Alice and Bob may thus be significant, because the satellite has to move from one station to another and the weather conditions must be favorable for each of them at the time when the satellite passes.

It is known to use a satellite constellation via which the key is propagated from Alice to Bob. However, such a solution is relatively complex and expensive. Furthermore, depending on the geometry of the constellation, it is not always possible to establish an inter-satellite link (ISL) between any two satellites of the constellation. A key might be stored on board a satellite for a long time, waiting for said satellite to have a window of visibility with a receiving satellite, before it is able to be erased. However, the storage capacities of a satellite are limited.

There is therefore a search for a solution for reducing the delay between a request for pairing between two ground stations and execution thereof, in a satellite quantum cryptographic key distribution method.

To this end, the invention relates to a centralized satellite quantum cryptographic key pairing method for a plurality of ground stations, the method comprising, in the following order:
a quantum key distribution step, in which, for each ground station, at least one respective cryptographic key, referred to as “key linked to the ground station”, is shared through quantum communication between the ground station and a satellite, referred to as “key establishment satellite”;
a centralized key storage step, in which each key linked to a ground station is first transmitted in encrypted form from the key establishment satellite to a terrestrial central key management unit, and then stored by this terrestrial central key management unit; and
a pairing step between a first and a second of said ground stations, in which, upon receipt of a request for communication between the first ground station and the second ground station, the terrestrial central key management unit transmits the key linked to the second ground station, in encrypted form, to the first ground station.

A secure stock of cryptographic keys is thus first created for the ground stations, and then these keys are distributed upon request so as to establish encrypted communication between ground stations. By virtue of these key distribution and centralized key storage steps, the keys are available upon a subsequent request to establish a link between ground stations. Once the stock of cryptographic keys has been created, the process of pairing the cryptographic keys shared between two ground stations is therefore no longer dependent on the constraints of the satellite system (visibility, mission, availability of the atmospheric channel, etc.). The pairing delay between two ground stations is then improved compared to the prior art, and the distribution of the key pairs may be adapted according to needs at the time.

According to one embodiment, in the pairing step between the first ground station and the second ground station, the terrestrial central key management unit also transmits the key linked to the first ground station, in encrypted form, to the second ground station.

According to one embodiment, in the pairing step, the one or more encrypted transmissions comprise transmitting a parity sequence, the result of an exclusive OR function XOR between the key linked to the first ground station and the key linked to the second ground station.

According to one embodiment, in the centralized key storage step, each key linked to a ground station is transmitted in encrypted form by way of a key shared between the key establishment satellite and the terrestrial central key management unit.

According to one variant, in the centralized key storage step, the encrypted transmission of the key linked to the ground station between the key establishment satellite and the terrestrial central key management unit comprises transmitting a parity sequence, the result of an exclusive OR function XOR between the key linked to the ground station and the key shared between the key establishment satellite and the terrestrial central key management unit.

According to one variant, the method comprises, before the centralized key storage step, a first preliminary satellite quantum key distribution step, in which the key shared between the key establishment satellite and the terrestrial central key management unit is shared through quantum communication between the key establishment satellite and the terrestrial central key management unit.

According to one embodiment, the method furthermore comprises, with the key establishment satellite belonging to a satellite constellation, selecting a satellite from the satellite constellation to be key establishment satellite based on communication conditions with the ground station.

According to one embodiment, the terrestrial central key management unit is at least partially present within a mission control center of the key establishment satellite or of the satellite constellation.

According to one embodiment, for at least one ground station, multiple keys linked to the ground station and shared through quantum communication are stored in the terrestrial central key management unit.

The invention furthermore relates to a centralized satellite quantum cryptographic key pairing system for a plurality of ground stations, the system comprising at least one satellite, referred to as “key establishment satellite”, and at least one terrestrial central key management unit, which are configured to implement a method according to the invention.

Other features and advantages of the present invention will become more apparent on reading the following description with reference to the following appended figures:

FIG. 1, already described, shows a satellite quantum cryptographic key distribution method according to the prior art;

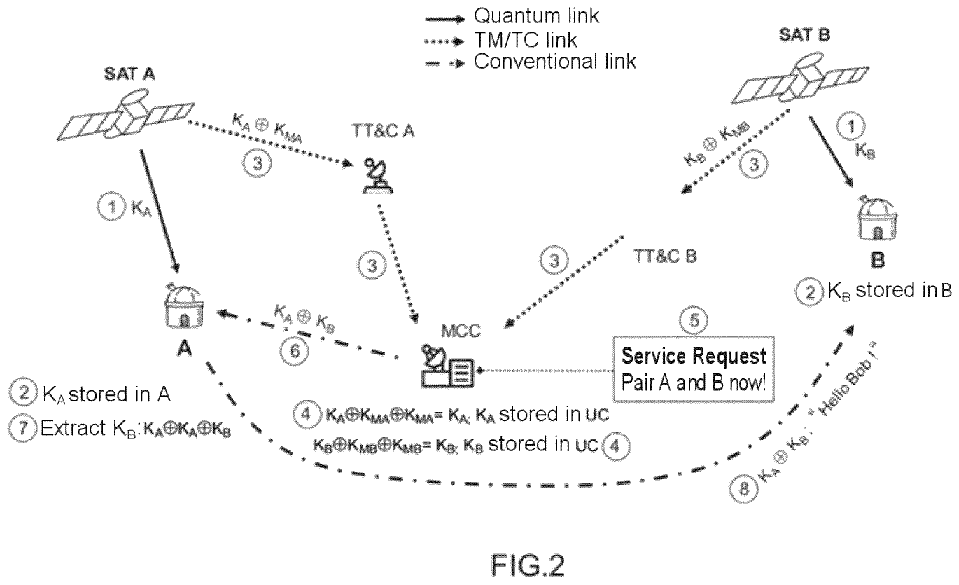

FIG. 2 shows one example of a centralized satellite quantum cryptographic key pairing method according to the invention.

The steps of one example of a method according to the invention will be described with reference to FIG. 2. The method allows quantum key pairing between two ground stations A, B. The method may be applied to more than two ground stations. The ground stations A, B comprise notably communication means for communicating with one or more satellites.

In a quantum key distribution step 1, for each ground station A, B, at least one cryptographic key K_{A}, K_{B}, referred to as “key linked to the ground station”, is shared through quantum communication between the ground station A, B and a satellite SAT A, SAT B, referred to as “key establishment satellite”. Quantum communication is thus established between a first ground station A and a first key establishment satellite SAT A. A key K_{A} linked to the first ground station A is shared between the first ground station A and the first key establishment satellite SAT A at the end of this quantum communication. Still in this quantum key distribution step 1, in similar fashion, quantum communication is established between a second ground station B and a second key establishment satellite SAT B. A key K_{B} linked to the second ground station B is shared between the second ground station B and the second key establishment satellite SAT B through this quantum communication.

At the end 2 of the quantum key distribution step, the key K_{A} linked to the first ground station A is shared between the first ground station A and the first key establishment satellite SAT A; the key K_{B} linked to the second ground station B is shared between the second ground station B and the second key establishment satellite SAT B. In other words, each key K_{A}, K_{B} linked to a ground station A, B is stored in the respective ground station A, B and in the respective key establishment satellite SAT A, SAT B.

Next, in a centralized key storage step 3, each key K_{A}, K_{B}, linked to a ground station A, B, is transmitted, in encrypted form, from the key establishment satellite SAT A, SAT B to a central key management unit UC. The central key management unit UC stores, notably securely, the keys K_{A}, K_{B} linked to the ground stations A, B. In other words, the first key establishment satellite SAT A sends the key K_{A} linked to the first ground station A, in encrypted form, to the central key management unit UC; and the second key establishment satellite SAT B sends the key K_{B} linked to the second ground station B, in encrypted form, to the central key management unit UC. The central key management unit UC thus centralizes all of the keys K_{A}, K_{B} linked to the ground stations A, B, which were previously shared between the ground stations A, B and the key establishment satellites SAT A, SAT B in the key distribution step 1. The central key management unit UC is terrestrial, that is to say located on the ground, thereby making it less complex to implement and more easily accessible compared to a satellite.

At the end 4 of the centralized key storage step 3, the keys K_{A}, K_{B} are therefore all stored and available in the central key management unit UC, for pairing between two ground stations A, B. The key establishment satellite SAT A, SAT B may delete the key K_{A}, K_{B} linked to the ground station A, B, in order notably to free up memory space on board.

A service request 5 to the central unit UC initiates a pairing step 6 between the first ground station A and the second ground station B. Such a service request 5 requests pairing of the first ground station A with the second ground station B, namely the provision of one of the keys K_{A}, K_{B} linked to the ground stations that are to communicate with one another.

In the pairing step 6, the central key management unit UC then transmits the key K_{B} linked to the second ground station B, in encrypted form, to the first ground station A.

At the end 7 of the pairing step 6, the key K_{B} linked to the second ground station B is available in the first ground station A.

Next, in a communication step 8, the first ground station A may then send an encrypted message to the second ground station B using the key K_{B} linked to the second ground station B. However, the first ground station A and the second ground station B might not be the users of the keys K_{A}, K_{B}. They then supply their key K_{A}, K_{B} to their respective user, notably via a terrestrial link. Users may connect to the ground stations A, B via a local or remote communication network. Preferably, the link between the ground station A, B and the user is encrypted by a key shared through quantum communication. However, the key could be shared using other means. For example, the key could be defined during the design of the ground station A, B and the user. For example, the users may be satellites.

By virtue of the quantum key distribution step and the step of centralized storage of said quantum keys in the central key management unit UC, upon a subsequent pairing request, the keys are available immediately, notably within the limits of the performance of terrestrial links through which the pairing request and the key K_{B} linked to the second ground station B transit. An urgent pairing request may thus be satisfied, which was not the case in the prior art. Satisfaction thereof is no longer liable to be delayed due to adverse weather and/or overflight conditions at the ground stations. Indeed, the method transfers these uncertainties to the preliminary key distribution step. Advantageously, the pairing requested between ground stations may be carried out as late as possible, notably when the need arises for communication between the ground stations A, B. There is no need to schedule pairing far in advance, with the risk of said pairing being useless. The advantages of the method make it possible to reduce the differences between the operation of terrestrial QKD infrastructures and that of satellite QKD infrastructures, thus facilitating integration between terrestrial and satellite systems.

The key distribution step 1 and the centralized key storage step 3 are notably carried out for all of the ground stations A, B, before any pairing step 6 between ground stations A, B.

In particular, in the centralized key storage step 3, for the transmission of the key K_{A}, K_{B} linked to the ground station A, B to the central unit UC, the key establishment satellite SAT A, SAT B uses a respective key K_{MA}, K_{MB} shared between the key establishment satellite SAT A, SAT B and the central key management unit UC.

The key establishment satellite SAT A, SAT B notably carries out an exclusive OR function between the key K_{A}, K_{B} linked to the ground station A, B and the key K_{MA}, K_{MB} shared between the key establishment satellite SAT A, SAT B and the central key management unit UC. The parity sequence K_{A}⊕KMA K_{B}⊕KMB that is obtained is then transmitted to the central key management unit UC. For this purpose, the central key management unit UC may implement the one-time pad (OTP) encryption technique. The link between the key establishment satellite SAT A, SAT B and the central key management unit UC may thus be implemented by an open link, notably a non-quantum link, for example by an optical or radiofrequency RF link.

In particular, at the end 4 of the centralized key storage step 3, the central key management unit UC extracts the key K_{A}, K_{B} linked to the ground station A, B from the parity sequence K_{A}⊕KMA, K_{B}⊕KMB transmitted by the key establishment satellite SAT A, SAT B. In particular, if the security level is increased as a result, this decryption of the key K_{A}, K_{B} linked to the ground station A, B may be performed upon receipt of the request 5 for communication between the first ground station A and the second ground station B.

The key K_{MA}, K_{MB} shared between the key establishment satellite SAT A, SAT B and the central key management unit UC is notably shared in quantum form in a first preliminary satellite quantum key distribution step. The first preliminary satellite quantum key distribution step is implemented before the centralized key storage step 3, so as to allow secure encrypted transmission of the keys K_{A}, K_{B} linked to the ground stations A, B to the central key management unit UC. Thus, a first key K_{MA} is shared through quantum communication between the first key establishment satellite SAT A and the central key management unit UC; and a second key K_{MB} is shared through quantum communication between the second key establishment satellite SAT B and the central key management unit UC. Preferably, the first preliminary quantum key distribution step is implemented before the quantum key distribution step 1 for the keys linked to the ground stations A, B, so as to allow transmission of the keys K_{A}, K_{B} linked to the ground stations A, B immediately after they have been shared between the ground station A, B and the key establishment satellite SAT A, SAT B.

However, the key K_{MA}, K_{MB} shared between the key establishment satellite SAT A, SAT B and the central key management unit UC could be obtained in other ways, if the security level allows this. For example, it could be defined during the design of the key establishment satellite SAT A, SAT B and placed on board prior to launch thereof.

In particular, the first key establishment satellite SAT A and the second key establishment satellite SAT B may correspond to one and the same satellite traveling a distance for quantum sharing of the key K_{A} linked to the first ground station A, then the key K_{B} linked to the second ground station B, or vice versa. As an alternative, the first key establishment satellite SAT A and the second key establishment satellite SAT B may correspond to two different satellites, notably belonging to a satellite constellation.

In particular, when a satellite constellation is available, the quantum key distribution step for keys K_{A}, K_{B} linked to the ground stations A, B comprises, for each ground station A, B, selecting a satellite of the constellation to be key establishment satellite SAT A, SAT B, depending on the communication conditions with the ground station A, B. The key establishment satellite SAT A, SAT B is notably the one in the satellite constellation having the most favorable communication conditions with the ground station A, B, for example the one closest to the ground station A, B and/or benefiting from weather conditions characterized by the lowest cloud cover and/or the one benefiting from nighttime transmission rather than daytime transmission. The use of a satellite constellation makes it possible, inter alia, to increase the number of opportunities to establish quantum communications with the ground stations A, B when conditions are favorable.

In the centralized key storage step 3, the encrypted transmission of the keys K_{A}, K_{B} linked to the ground stations A, B uses notably the infrastructure of the satellite constellation. For example, the key establishment satellite SAT A, SAT B transmits the key K_{A}, K_{B} in encrypted form via an open link to a telemetry, telecommand and control (TT&C) station, although another path is conceivable. The TT&C station is notably a relay antenna for the satellite constellation, which is known per se. The TT&C station then relays the encrypted transmission of the key K_{A}, K_{B} linked to the ground station A, B to a mission control center (MCC). In a manner known per se, the role of the MCC is to manage the satellite constellation. The encrypted transmission of the key K_{A}, K_{B} linked to the ground station A, B takes place notably via a TM/TC link, that is to say a telemetry-telecontrol link, in particular in the form of a radiofrequency link.

The encrypted transmission of the keys K_{A}, K_{B} linked to the ground stations A, B may also use inter-satellite links. One or more satellites of the constellation may serve as a relay between the key establishment satellite SAT A, SAT B and the TT&C station. The transmission may then be encrypted end-to-end and/or be encrypted step-by-step. The use of one or more keys shared through quantum communication is preferred.

The central key management unit UC is notably present within the mission control center. This is particularly advantageous because, by virtue of its function as manager of the satellite constellation, the mission control center is highly secure, both digitally so as to avoid any computer infiltration and physically due to guarding, differentiated access authorizations, safes for example. The security level of the mission control center is notably compatible with a trusted node function. The central key management unit UC may then benefit from these security means. The central key management unit UC is preferably present completely within the mission control center. As an alternative, the central key management unit UC is present partially within the mission control center or completely outside the mission control center. The communication between the mission control center and the central key management unit UC is then preferably highly secure, for example secured by a key shared through quantum communication.

The central key management unit UC may be on a single site.

As an alternative, the central key management unit UC may be distributed across multiple sites. If necessary, in the centralized key storage step 3, each key K_{A}, K_{B} linked to a ground station A, B is transmitted to a site of the central key management unit UC. A synchronization mechanism is notably implemented between the sites of the central key management unit UC, in order to manage the distribution of the keys linked to the ground stations A, B.

Preferably, the method then comprises a second preliminary site quantum key distribution step, in which keys are shared through quantum communication between the sites of the central key management unit UC. The second preliminary site quantum key distribution step is implemented before the centralized key storage step 3, so as to allow secure encrypted transmission of the key K_{A}, K_{B} linked to the ground station A, B to the respective site of the central unit UC. Preferably, the second preliminary quantum key distribution step is implemented before the quantum key distribution step 1 for the keys linked to the ground stations A, B, so as to allow transmission of the keys K_{A}, K_{B} linked to the ground stations A, B immediately after they have been shared between the ground station A, B and the key establishment satellite SAT A, SAT B.

The first preliminary satellite quantum key distribution step and/or the second preliminary site quantum key distribution step are implemented notably during an initial configuration of the system implementing the method, in particular before any quantum key distribution step 1 for keys linked to the ground stations A, B. Such an initial configuration may take place during first commissioning of the system or after an update of the system.

In particular, in the pairing step 6, the encrypted transmission of the key K_{B} linked to the second ground station B to the first ground station A comprises transmitting a parity sequence K_{A}⊕K_{B} resulting from the exclusive OR function between the key K_{A} linked to the first ground station A and the key K_{B} linked to the second ground station B. To this end, the central key management unit UC may implement the one-time pad (OTP) encryption technique. It is therefore not necessary to define a key shared between each ground station A, B and the central key management unit UC.

In particular, at the end 7 of the pairing step 6, the first ground station A extracts the key K_{B} linked to the second ground station B from the parity sequence K_{A}@K_{B} transmitted by the central key management unit UC.

Next, in the communication step 8, the first ground station A may then send a parity sequence K_{A}⊕K_{B} resulting from the exclusive OR function between the key K_{A} linked to the first ground station A and the key K_{B} linked to the second ground station B, so that the second ground station B also possesses the key K_{A} of the first ground station A.

The key K_{A} of the first ground station A may also be transmitted, in encrypted form, to the second ground station B in the pairing step 6. For this purpose, the central key management unit UC also sends the parity sequence K_{A}⊕K_{B} to the second ground station B, so that the latter extracts the key K_{A} linked to the first ground station A, as described with reference to the first ground station A.

In particular, the links between the ground stations A, B and the central key management unit UC are terrestrial, or even solely terrestrial, that is to say implemented by ground infrastructures such as for example communication cables, optical fibers or mobile telecommunications systems.

The one or more key establishment satellites SAT A, SAT B and the central key management unit UC are therefore part of a centralized quantum cryptographic key pairing system for a plurality of ground stations A, B.

The one or more key establishment satellites SAT A, SAT B and/or the central key management unit UC, as trusted nodes in the key exchange between the ground stations A, B, are preferably highly secure against digital and physical attacks by appropriate protection means, in accordance with the rules in the art for critical infrastructures. The central key management unit UC thus securely stores the keys K_{A}, K_{B} linked to the ground stations A, B. The one or more key establishment satellites SAT A, SAT B may store the keys K_{A}, K_{B} linked to the ground stations A, B transiently and securely.

In order to carry out the quantum key distribution step 1 for keys linked to the ground stations A, B, the one or more key establishment satellites SAT A, SAT B and the ground stations A, B are preferably each equipped with quantum optical terminals. For example, the quantum optical terminal of the key establishment satellite SAT A, SAT B comprises a photonic source; and the quantum optical terminal of the ground station A, B comprises, inter alia, a qubit analyzer and single-photon detectors. The central key management unit UC may also be equipped with a quantum optical terminal, in order to be able to implement the first preliminary satellite quantum key distribution step.

A ground station A, B may be fixed or mobile, such as for example a boat or a submarine.

For at least one of the ground stations A, B, or even all of them, multiple keys linked to the ground station may be shared through quantum communication between the ground station and the key establishment satellite, and stored in parallel in the central key management unit UC. These keys are notably shared between the ground station and the key establishment satellite, in one and the same key distribution step 1 or in temporally separate key distribution steps 1. Thus, multiple keys linked to the ground station A, B may be available in advance, thereby improving the responsiveness of the method upon receipt of a pairing request. This is particularly advantageous for a ground station with a very high workload.

It is preferable, for each ground station A, B, for at least a minimum number of keys K_{A}, K_{B} to be available in the central unit UC at all times, so that a pairing request concerning any of the ground stations A, B is able to be satisfied immediately.

For example, the quantum communication between the ground station A, B and the key establishment satellite SAT A, SAT B or that between the key establishment satellite SAT A, SAT B and the central key management unit UC, or else any other quantum communication described in relation to the invention, implement a QKD method that is known per se, for example with a prepare and measure protocol, such as the BB84 protocol.

The sharing of a key in quantum form or through quantum communication is understood to mean notably the establishment, through quantum communication between two entities, of a cryptographic key established by exploiting effects of quantum physics, the quantum cryptographic key being shared between the two entities at the end of this quantum communication. In particular, the cryptographic key is a random sequence of logic bits 0 and 1; and it is said to be “quantum” only because it is established through quantum communication.

1. A centralized satellite quantum cryptographic key pairing method for a plurality of ground stations (A, B), the method comprising, in the following order:
a quantum key distribution step wherein, for each ground station (A, B), at least one respective cryptographic key (K_{A}, K_{B}), referred to as “key linked to the ground station”, is shared through quantum communication between the ground station (A, B) and a satellite (SAT A, SAT B), referred to as “key establishment satellite”;
a centralized key storage step, wherein each key (K_{A}, K_{B}) linked to a ground station (A, B) is first transmitted in encrypted form from the key establishment satellite (SAT A, SAT B) to a terrestrial central key management unit (UC), and then stored by this terrestrial central key management unit (UC); and
a pairing step between a first (A) and a second (B) of said ground stations, in which, upon receipt of a request for communication between the first ground station (A) and the second ground station (B), the terrestrial central key management unit (UC) transmits the key (K_{B}) linked to the second ground station (B), in encrypted form, to the first ground station (A).

2. The method according to claim 1, wherein:
in the pairing step between the first ground station (A) and the second ground station (B), the terrestrial central key management unit (UC) also transmits the key (K_{A}) linked to the first ground station (A), in encrypted form, to the second ground station (B).

3. The method according to claim 1, wherein, in the pairing step, the one or more encrypted transmissions comprise transmitting a parity sequence K_{A}⊕K_{B}, the result of an exclusive OR function XOR between the key (K_{A}) linked to the first ground station (A) and the key (K_{B}) linked to the second ground station (B).

4. The method according to claim 1, in the centralized key storage step, each key (K_{A}, K_{B}) linked to a ground station (A, B) is transmitted in encrypted form by way of a key (K_{MA}, K_{MB}) shared between the key establishment satellite (SAT A, SAT B) and the terrestrial central key management unit (UC).

5. The method according to claim 4, wherein, in the centralized key storage step (3), the encrypted transmission of the key (K_{A}, K_{B}) linked to the ground station (A, B) between the key establishment satellite (SAT A, SAT B) and the terrestrial central key management unit (UC) comprises transmitting a parity sequence (K_{A}⊕KMA, K_{B}⊕KMB), the result of an exclusive OR function XOR between the key (K_{A}, K_{B}) linked to the ground station (A, B) and the key (K_{MA}, K_{MB}) shared between the key establishment satellite (SAT A, SAT B) and the terrestrial central key management unit (UC).

6. The method according to claim 4, comprising, before the centralized key storage step, a first preliminary satellite quantum key distribution step, in which the key (K_{MA}, K_{MB}) shared between the key establishment satellite (SAT A, SAT B) and the terrestrial central key management unit (UC) is shared through quantum communication between the key establishment satellite (SAT A, SAT B) and the terrestrial central key management unit (UC).

7. The method according to claim 1, furthermore comprising, with the key establishment satellite (SAT A, SAT B) belonging to a satellite constellation, selecting a satellite from the satellite constellation to be key establishment satellite (SAT A, SAT B) based on communication conditions with the ground station (A, B).

8. The method according to claim 1, wherein the terrestrial central key management unit (UC) is at least partially present within a mission control center (MCC) of the key establishment satellite (SAT A, SAT B) or of the satellite constellation.

9. The method according to claim 1, wherein, for at least one ground station (A, B), multiple keys (K_{A}, K_{B}) linked to the ground station (A, B) and shared through quantum communication are stored in the terrestrial central key management unit (UC).

10. A centralized satellite quantum cryptographic key pairing system for a plurality of ground stations (A, B), the system comprising at least one satellite (SAT A, SAT B), referred to as “key establishment satellite”, and at least one terrestrial central key management unit (UC), which are configured to implement a method according to claim 1.
